(19) United States
(12) Patent Application Publication
(10) Pub. No.: US 2006/0061534 A1
(43) Pub. Date: Mar. 23, 2006

(54) Liquid crystal display

(75) Inventor: Baek-Woon Lee, Yongin-si (KR)

Correspondence Address: MCGUIREWOODS, LLP, 1750 TYSONS BLVD, SUITE 1800, MCLEAN, VA, 22102, US

(73) Assignee: Samsung Electronics Co., Ltd.

(21) Appl. No.: 11/224,038

(22) Filed: Sep. 13, 2005

(30) Foreign Application Priority Data
Sep. 17, 2004 (KR) 10-2004-0074595

(51) Int. Cl. G09G 3/36

(52) U.S. Cl. 345/92

(57) ABSTRACT

An LCD includes a plurality of pixel rows including a plurality of pixels in a matrix-like arrangement, each of the pixel rows having a first switching element, a second switching element, and a pixel electrode coupled with the first switching element and the second switching element, a plurality of gate lines coupled with the first switching elements to transmit gate-on voltages thereto, and a plurality of data lines coupled with the first switching element and the second switching element to transmit data voltages. The first switching element and the second switching element at each of the respective pixels are coupled with data lines that are different from each other, and the second switching elements are in a turned-off state.

### CROSS REFERENCE TO RELATED APPLICATION

This application claims priority to and the benefit of Korean Patent Application No. 10-2004-0074595, filed on Sep. 17, 2004, which is hereby incorporated by reference for all purposes as if fully set forth herein.

### BACKGROUND OF THE INVENTION

1. Field of the Invention

The present invention relates to a liquid crystal display, and in particular, to an inversion driving liquid crystal display.

2. Description of Related Art

A liquid crystal display (“LCD”) includes two panels with pixel electrodes and common electrodes, and a liquid crystal layer having dielectric anisotropy arranged between the two panels. The pixel electrodes are arranged in a matrix-like form, and are connected to switching elements such as TFTs to sequentially receive data voltages row by row. The common electrode is arranged on the entire surface of the panel to receive a common voltage. The pixel electrode, the common electrode, and the liquid crystal layer arranged between the electrodes form a liquid crystal capacitor, which functions as a basic unit for a pixel together with the switching element connected thereto.

A voltage is applied to the two electrodes to generate an electric field around the liquid crystal layer and the intensity of the electric fields is controlled to adjust the light transmittance through the liquid crystal layer and obtain a desired image. In order to prevent the liquid crystal layer from deteriorating due to a long-term application of a one-directional electric field thereto, the polarity of the data voltage with respect to the common voltage is inverted per frame, row, or pixel.

The data voltage may be inverted by inverting the polarity of the data voltage per frame (referred to as “frame inversion”) such that the pixels at successive frames have opposite polarity. In this case, an electric charge of Q=2CV, where C is the sum of the liquid crystal capacitance and the storage capacitance, is necessary to shift the pixel charged at −V into the pixel charged at +V. The charge should be made for one horizontal cycle 1H, during which the switching elements of one row are all opened. However, when the liquid crystal device being displayed with a high resolution having a relatively short horizontal cycle is insufficient or when the driving capacity of the switching elements is insufficient, it becomes difficult to obtain all the needed electric charges, thereby decreasing the image quality. When the dimensions of the switching elements are enlarged to increase the driving capacity thereof, the aperture ratio is reduced, thereby decreasing the luminance of the display device.

Meanwhile, when the polarity of the data voltage is inverted per pixel (referred to as “dot inversion”), vertical flicker or vertical crosstalk caused by a kickback voltage is reduced, thereby improving the image quality. However, as the polarity of the data voltage is inverted for a predetermined numbers of rows and columns, applying voltage to the data lines is complicated, resulting in signal delay at the data lines. In order to prevent such signal delay, data lines formed of a low resistance material are provided together with other necessary conditions, which complicates and adds cost to the relevant processing steps.

By contrast, when the polarity of the data voltage is inverted for a predetermined numbers of columns (referred to as “column inversion”), the polarity of the data voltage flowing through one data line is inverted only per frame, thereby reducing the signal delay at the data lines. However, column inversion does not have the advantages of the dot inversion, and the image quality of the LCD deteriorates because of vertical flickering and vertical crosstalking.

### SUMMARY OF THE INVENTION

It is an object of the present invention to provide a liquid crystal display which involves improved image quality.

Additional features of the invention will be set forth in the description which follows, and in part will be apparent from the description, or may be learned by practice of the invention.

The present invention discloses a liquid crystal display (LCD), including: a plurality of pixel rows having a plurality of pixels arranged in a matrix-like form, each pixel row having a first switching element, a second switching element, and a pixel electrode coupled with the first switching element and the second switching element; a gate lines coupled with each of the first switching elements to transmit a gate-on voltage thereto; and a data line coupled with each of the first switching elements and the second switching elements to transmit a data voltage, wherein the first switching element and the second switching element at each of the respective pixels are coupled with data lines that are different from each other, and the second switching element is in a turned-off state.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention

FIG. 1 is a block diagram of an LCD according to an embodiment of the invention.

FIG. 2 is an equivalent circuit diagram of a pixel of an LCD according to an embodiment of the invention.

FIG. 3 is an equivalent circuit diagram of a pixel electrode and a parasitic capacitor, showing the voltage variation of the pixel electrode according to an embodiment of the invention.

FIG. 4 is another equivalent circuit diagram of a pixel of an LCD according to an embodiment of the invention.

FIG. 5 is still another equivalent circuit diagram of a pixel of an LCD according to an embodiment of the invention.

FIG. 6 shows an arrangement of switching elements of pixels using the column inversion according to an embodiment of the invention.

FIG. 7 shows an arrangement of switching elements of pixels realizing the 1×1 dot inversion according to an embodiment of the invention.

FIG. 8A and FIG. 8B show an arrangement of switching elements of pixels realizing the 2×1 dot inversion according to an embodiment of the invention, respectively.

FIG. 9 is a timing diagram of gate signals for making a preliminary charge according to an embodiment of the invention.

FIG. 10 is a graph showing the vertical crosstalk as a function of gate-off voltage with an LCD according to an embodiment of the invention and a conventional LCD.

### DESCRIPTION OF THE ILLUSTRATED EMBODIMENTS

In the drawings, the thickness of layers and regions are exaggerated for clarity. Like numerals refer to like elements throughout. It will be understood that when an element such as a layer, film, region, substrate, or panel is referred to as being “on” another element, it can be directly on the other element or intervening elements may also be present. In contrast, when an element is referred to as being “directly on” another element, there are no intervening elements present.

LCDs according to embodiments of the present invention are described below with reference to the figures.

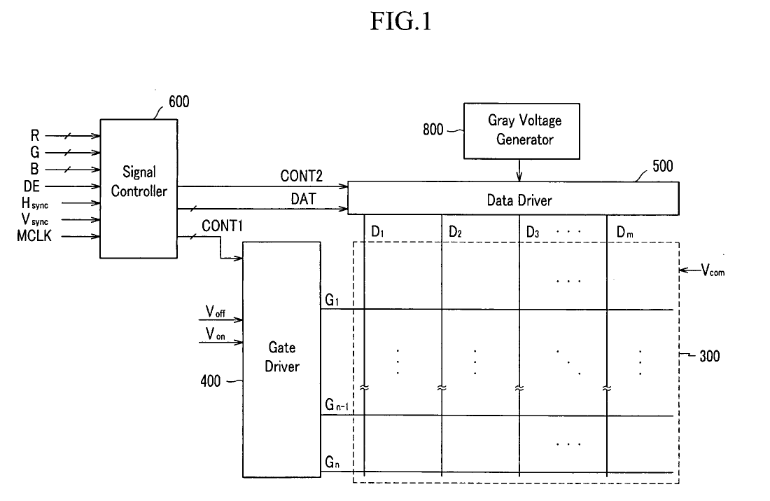

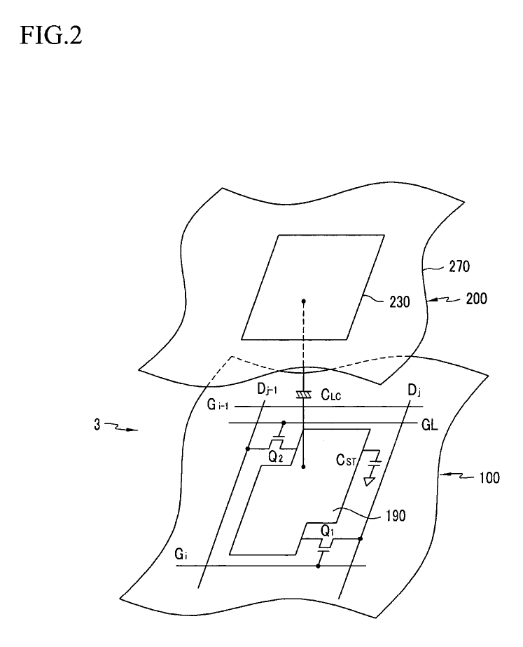

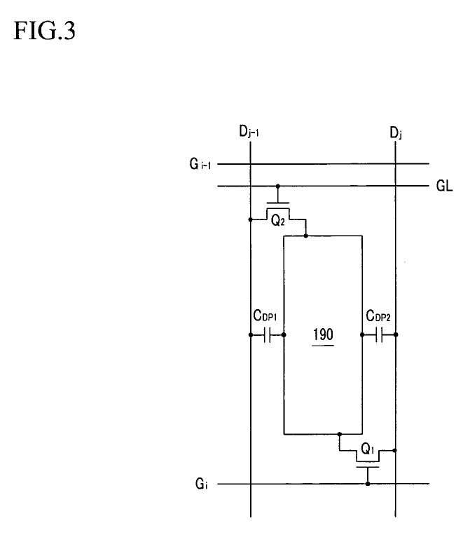

FIG. 1 is a block diagram of an LCD according to an embodiment of the invention. FIG. 2 is an equivalent circuit diagram of a pixel for an LCD according to an embodiment of the invention. FIG. 3 is an equivalent circuit diagram of a pixel electrode and a parasitic capacitor according to an embodiment of the invention, showing the voltage variation of the pixel electrode.

As shown in FIG. 1, an LCD includes a liquid crystal panel assembly 300, a gate drawing unit 400 and a data driving unit connected, e.g., coupled, with the liquid crystal panel assembly 300, a gray voltage generation unit 800 connected, e.g., coupled, with the data driving unit 500, and a signal control unit 600 for controlling them.

The liquid crystal panel assembly has a plurality of display signal lines G1-Gn and D1-Dm and voltage lines GL, and a plurality of pixels arranged in a matrix-like form.

The display signal lines G1-Gn and D1-Dm include a plurality of gate lines G1-Gn for transmitting gate signals, e.g., scanning signals, and a plurality of data lines D1-Dm for transmitting data signals. The gate lines G1-Gn are arranged in a row direction and are substantially parallel to each other, and the data lines D1-Dm are arranged in a column direction and are substantially parallel to each other.

The voltage lines GL are connected, e.g., coupled, with each other in parallel to transmit gate-off voltages for turning off the switching elements.

Each pixel includes main switching elements Q1 and subsidiary switching elements Q2 connected, e.g., coupled, with the display signal lines G1-Gn and D1-Dm and the voltage lines GL, and a liquid crystal capacitor C_{LC} and a storage capacitors C_{ST} connected, e.g., coupled, with the main switching element Q1 and the subsidiary switching element Q2. The storage capacitor C_{ST} may be omitted.

As shown in FIG. 2, the main switching element Q1 and the subsidiary switching element Q2 are arranged at a lower panel 100. Each of the main switching element Q1 and the subsidiary switching element Q2 have a control terminal, an input terminal, and an output terminal connected, e.g., coupled, with the data lines Dj-1 and Dj different from each other as a three-terminal device.

For example, the control terminal of the main switching element Q1 at the j^{th} pixel of the i^{th} pixel row (i,j) is connected, e.g., coupled, with the i^{th} gate line G1, the input terminal thereof to the j^{th} data line Dj, and the output terminal thereof is connected, e.g., coupled, with the liquid crystal capacitor C_{LC}. Furthermore, the control terminal of the subsidiary switching element Q2 at the (i,j) pixel is connected, e.g., coupled, with the voltage line GL, the input terminal thereof is connected, e.g., coupled, with the (j-1)^{th} data line Dj-1, and the output terminal thereof is connected, e.g., coupled, with the liquid crystal capacitor C_{LC}. Accordingly, the subsidiary switching element Q2 is kept at a turned-off state, and involves leakage current.

The liquid crystal capacitor C_{LC} includes a pixel electrode 190 on the lower panel 100 and a common electrode 270 on an upper panel 200 as two terminals, and a liquid crystal layer 3 is arranged between the two electrodes 190 and 279 as a dielectric layer. The pixel electrode 190 is connected, e.g., coupled, with the main switching element Q1 and the subsidiary switching element Q2, and the common electrode 270 is arranged on the entire surface of the upper panel 200 to receive a common voltage Vcom. The common electrode 270 may be provided on the lower panel 100 which is different from the structure shown in FIG. 2, and the electrodes 190 and 270 have a line-like shape or a bar-like shape.

The storage capacitor C_{ST} supports the liquid crystal capacitor C_{LC} and a separate signal line (not shown) provided at the lower panel 100 overlaps or crosses the pixel electrode 190 and an insulator is arranged therebetween, and a predetermined voltage, such as a common voltage Vcom, is applied to the separate signal line. Alternatively, the storage capacitor C_{ST} may be formed by overlapping the pixel electrode 190 with the previous gate line via an insulator.

As described above, the pixel electrode 190 is connected, e.g., coupled, with the gate line G1, the voltage line GL, and the data lines Dj-1 and Dj via the main switching element Q1 and the subsidiary switching element Q2. As discussed above and shown in FIG. 3, parasitic capacitors C_{DP1} and C_{DP2} are formed between the pixel electrode 190 and the two adjacent data lines Dj-1 and Dj, respectively. The main switching element Q1 and the subsidiary switching element Q2 are preferably designed such that the parasitic capacitors C_{DP1} and C_{DP2} have substantially the same capacitance and the leakage current flowing through the main switching element Q1 is substantially the same as the leakage current flowing through the subsidiary switching element Q2.

A region of a pixel is defined by the two adjacent gate lines G1-Gn and the two adjacent data lines D1-Dm, and the main switching element and the subsidiary switching element Q2 are arranged at each pixel. The main switching element Q1 is connected, e.g., coupled, with the lower-side gate line, and the subsidiary switching element Q2 is connected, e.g., coupled, with the voltage line GL. The main switching element Q1 and the subsidiary switching element Q2 are connected, e.g., coupled, with data lines different from each other. The voltage line may be placed at a location within the pixel, and the location of the subsidiary switching element Q2 is determined according to the location of the voltage line.

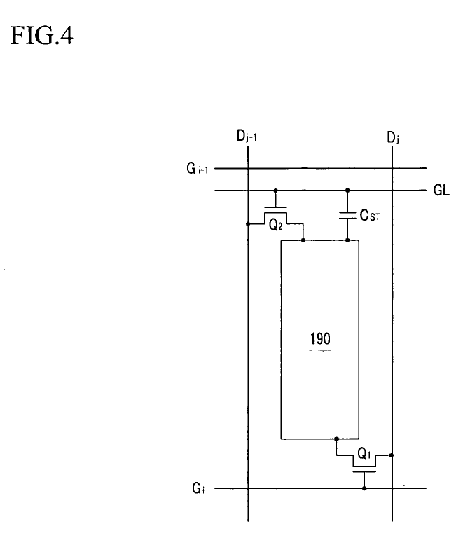

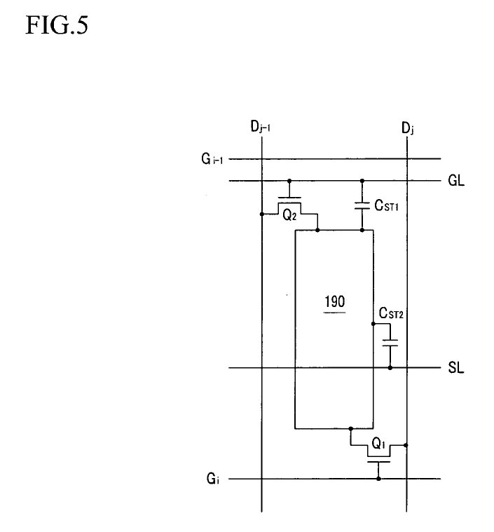

An arrangement of the subsidiary switching element and the storage capacitor at a pixel of an LCD according to an embodiment of the invention is discussed below with reference to FIG. 4 and FIG. 5.

FIG. 4 is another equivalent circuit diagram of a pixel of an LCD. FIG. 5 is still another equivalent circuit diagram of a pixel of an LCD according to an embodiment of the invention.

The pixel structure shown in FIG. 4 and FIG. 5 is substantially the same as the pixel structure shown in FIG. 3, except for a storage capacitor, and a detailed explanation of the same elements are omitted as necessary.

As shown in FIG. 4, an LCD includes a storage capacitor C_{ST}. The storage capacitor C_{ST} is provided between the pixel electrode 190 and the voltage line GL while being connected, e.g., coupled, thereto. With the storage capacitor C_{ST}, the voltage line GL and the pixel electrode 190 are overlapped with each other and an insulator is arranged therebetween. A gate-off voltage is applied to the voltage line GL to turn off the switching element.

According to the above described embodiment, the voltage line GL is both a signal line for transmitting the gate-off voltage to the subsidiary switching element Q2 and as a storage electrode line for the storage capacitor C_{ST}. Conversely, the storage electrode line commonly used in the pixel may be used as a signal line to transmit the gate-off voltage to the subsidiary switching element Q2, thereby eliminating the need for a separate wire. The subsidiary switching element Q2 is formed around the voltage line GL so that the aperture ratio of the pixel is not reduced.

Meanwhile, as shown in FIG. 5, an LCD according to an embodiment of the present invention may further include storage capacitors C_{ST1} and C_{ST2}, and a storage electrode line SL. The first storage capacitor C_{ST1} is arranged between the voltage line GL and the pixel electrode 190 while being coupled thereto, and the second storage capacitor C_{ST2} is arranged between the storage electrode line SL and the pixel electrode 190 while being coupled thereto. With the first storage capacitor C_{ST1}, the voltage line GL and the pixel electrode 190 are overlapped with each other and an insulator is arranged therebetween. With the second storage capacitor C_{ST2}, the storage electrode line SL and the pixel electrode 190 are overlapped with each other and an insulator is arranged therebetween. Thus, the storage capacitance at one pixel is substantially the sum of the capacitances at the respective storage capacitors C_{ST1} and C_{ST2}.

The storage electrode lines SL are connected, e.g., coupled, with each other in parallel. Signals where the voltage level is maintained constantly for at least 90% of one frame, such as a gate-off voltage, a common voltage Vcom, or a previous gate signal, are applied to the storage electrode line SL. The two storage capacitors C_{ST1} and C_{ST2} are charged with the data voltage at the relevant pixel even though the reference voltages thereof are different from each other.

Similar to the pixel shown in FIG. 4 and the pixel shown in FIG. 5, the voltage line GL is commonly used as the signal line to transmit the gate-off voltage to the subsidiary switching element Q2, and as the storage electrode line. Accordingly, a separate line is not needed and the aperture ratio of the pixel is not reduced.

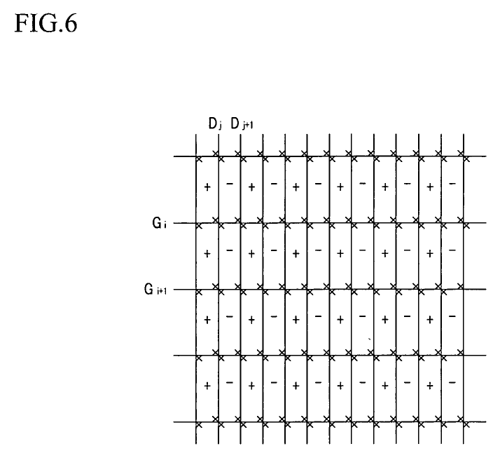

An arrangement of the main switching element and the subsidiary switching element with LCDs according to embodiments of the invention are described below with reference to FIGS. 6, 7, 8A, and 8B.

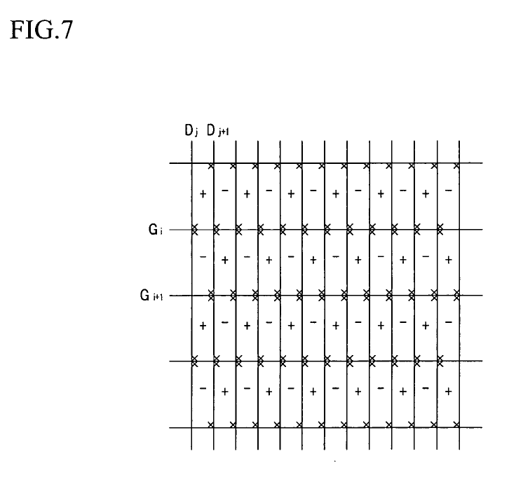

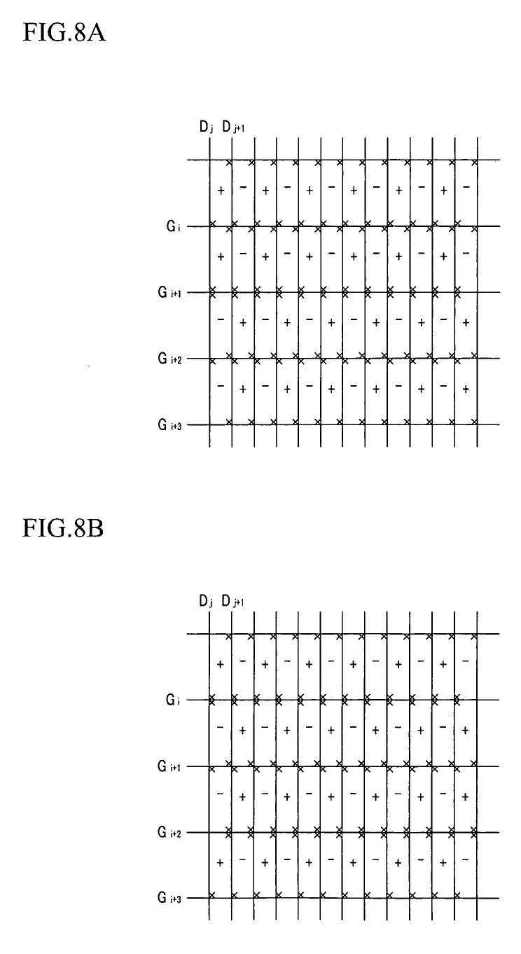

FIG. 6 shows an arrangement of switching elements at pixels where the column inversion is made according to an embodiment of the invention. FIG. 7 shows an arrangement of switching elements at pixels where the 1×1 dot inversion is made according to an embodiment of the invention. FIG. 8A and FIG. 8B show arrangements of switching elements at pixels where the 2×1 dot inversion is made according to an embodiment of the invention.

FIGS. 6, 7, 8A, and 8B show arrangements of switching elements at the pixels, e.g., the interconnection of main and subsidiary switching elements indicated by X, gate lines G-Gn, voltage lines GL, and data lines D1-Dm. The X mark at the lower gate line indicates the main switching element Q1, and the X mark at the upper voltage line GL indicates the subsidiary switching element Q2.

With the arrangements shown in FIGS. 6, 7, 8A, and 8B, the main switching element Q1 of each pixel is connected, e.g., coupled, with the lower gate line G1-Gn, and the subsidiary element Q2 is connected, e.g., coupled, with the upper voltage line GL. The main switching element Q1 and the subsidiary switching elements Q2 at the respective pixels are connected, e.g., coupled, with different-side data lines.

As shown in FIG. 6, the main switching elements Q1 are connected, e.g., coupled, with the same-side data lines, and the subsidiary switching elements Q2 are connected, e.g., coupled, with the same-side data lines.

Furthermore, with the arrangement shown in FIG. 7, the locations of the main switching elements Q1 and the subsidiary switching elements Q2 vary with each respective pixel row. That is, for example, with the neighboring pixel rows, the main switching elements Q1 are alternately connected, e.g., coupled, with the different-side data lines, and the subsidiary switching elements Q2 are alternately connected, e.g., coupled, with the different-side data lines.

With the four pixel rows shown in FIG. 7, the main switching elements Q1 at the topmost pixel row and the third pixel row are connected, e.g., coupled, with the left-side data lines, and the subsidiary switching elements Q2 are connected, e.g., coupled, with the right-side data lines. On the contrary, the main switching elements Q1 at the second pixel row and the fourth pixel row are connected, e.g., coupled, with the right-side data lines, and the subsidiary switching elements Q2 are connected, e.g., coupled, with the left-side data lines.

According to the arrangement illustrated in FIG. 8A and FIG. 8B, the locations of the main switching elements Q1 and the subsidiary switching elements Q2 vary per two pixel rows. That is, for example, the main switching elements Q1 placed within the two successive pixel rows (referred to hereinafter as the “pixel row group”) are connected, e.g., coupled, with the same-side data lines, and the subsidiary switching elements Q2 are connected, e.g., coupled, with the same-side data lines. The main switching elements Q1 and the subsidiary switching elements Q2 within the neighboring pixel row groups are connected, e.g., coupled, with the different-side data lines. The topmost or the bottommost pixel row of the liquid crystal panel assembly 300 shown in FIG. 1 may itself operate as a pixel row group.

With the four pixel rows shown in FIG. 8A, the main switching elements Q1 within the first pixel row group, that is, the two upper pixel rows, are connected, e.g., coupled, with the left-side data lines, and the subsidiary switching elements Q2 are connected, e.g., coupled, with the right-side data lines. On the contrary, the main switching elements Q1 within the second pixel row group, that is, the two lower pixel rows, are connected, e.g., coupled, with the right-side data lines, and the subsidiary switching elements Q2 are connected, e.g., coupled, with the left-side data lines.

According to the four pixel rows shown in FIG. 8B, the main switching elements Q1 within the first pixel row group, that is, the topmost pixel row, are connected, e.g., coupled, with the left-side data lines, and the subsidiary switching elements Q2 are connected, e.g., coupled, with the right-side data lines. The main switching elements Q1 within the second pixel row group, that is, the second and the third pixel rows, are connected, e.g., coupled, with the right-side data lines, and the subsidiary switching elements Q2 are connected, e.g., coupled, with the left-side data lines. The main switching elements Q1 within the last pixel row group, that is, the last pixel row, are connected, e.g., coupled, with the left-side data lines, and the subsidiary switching elements Q2 are connected, e.g., coupled, with the right-side data lines.

Accordingly, with the arrangement of the main switching elements Q1 and the subsidiary switching elements Q2 illustrated in FIGS. 7, 8A and 8B, the main switching elements Q1 within the respective pixel row groups including at least one pixel row are connected, e.g., coupled, with the same-side data lines, and the subsidiary switching elements Q2 are connected, e.g., coupled, with the same-side data lines. The main switching elements Q1 within the neighboring two pixel row groups are connected, e.g., coupled, with the opposite-side data lines, and the subsidiary switching elements Q2 are also connected, e.g., coupled, with the opposite-side data lines.

In order to display the colored images, each pixel intrinsically expresses one of the three primary colors (spatial division) or the respective pixels alternately express the three primary colors at time sequence (temporal division), thereby displaying the desired color images with the spatial or temporal sum of the three primary colors. FIG. 2 illustrates an example of the space division where each pixel is provided with a red, green, or blue color filter 230 corresponding to the pixel electrode 190. Unlike the structure shown in FIG. 2, the color filters 230 may be placed above or below the pixel electrodes 190 of the lower panel 100.

As shown in FIGS. 6, 7, 8A and 8B, the red, green, and blue color filters 230 are sequentially arranged in the row direction, and the respective pixel columns are stripe-patterned with the one-colored color filters 230. A polarizer (not shown) may be attached with the outer surface of at least one of the two panels 100 and 200 of the liquid crystal panel assembly 300 to polarize the light.

The gray voltage generation unit 800 generates multiple sets of gray voltages related to the light transmittance of the pixels. One set of the gray voltages has a positive value with respect to the common voltage Vcom, and another set of gray voltages has a negative value.

The gate driving unit 400 is connected, e.g., coupled, with the gate lines G1-Gn of the liquid crystal panel assembly 300 to apply the gate signals with the combination of the gate-on voltages Von and the gate-off voltages Voff from the outside to the gate lines G1-Gn. The gate driving unit 400 is commonly formed with a plurality of integrated circuits. The data driving unit 500 is connected, e.g., coupled, with the data lines D1-Dm of the liquid crystal panel assembly 300 to select the gray voltages from the gray voltage generation unit 800, and apply them to the pixels as data signals. The data driving unit 500 is commonly formed with a plurality of integrated circuits.

The plurality of gate driving integrated circuits or data driving integrated circuits may be attached to or mounted on a tape carrier package (“TCP.”) (not shown), which is attached with the liquid crystal panel assembly 300, or directly attached with a glass substrate without using the TCP (chip on glass, “COG”). Alternatively, circuits having the same function as the integrated circuits may be directly formed on the liquid crystal panel assembly 300 together with the thin film transistors of the pixels.

The signal control unit 600 generates control signals for operating the gate driving unit 400 and the data driving unit 500, and transmits the relevant control signals to the gate driving unit 400 and the data driving unit 500, respectively.

The display operation of the liquid crystal display is described below.

The signal control unit 600 receives RGB image signals and input control signals, which include vertical synchronization signals Vsync, horizontal synchronization signals Hsync, main clocks MCLK, and data enable signals DE, from an external graphics controller (not shown). The signal control unit 600 processes the RGB image signals based on the input RGB image signals and the input control signals such that they are adapted to the operation conditions of the liquid crystal panel assembly 300. The signal control unit 600 generates gate control signals CONT1 and data control signals CONT2 transmits the gate control signals CONT1 to the gate driving unit 400, and transmits the data control signals CONT2 and the processed image data DAT to the data driving unit 500.

The gate control signals CONT1 include vertical synchronization start signals STV for instructing to start outputting the gate-on voltage Von, and at least one clock signal for controlling the output of the gate-on voltage Von.

The data control signals CONT2 include horizontal synchronization start signals STH for instructing to start transmitting the image data DAT, load signals LOAD for instructing to apply the relevant data voltages to the data lines D1-Dm, reversal signals RVS for inverting the polarity of the data voltage with respect to the common voltage Vcom (referred to hereinafter as the “polarity of the data voltage”), and data clock signals HCLK.

The data driving unit 500 sequentially receives and shifts the image data DAT corresponding to the one pixel row in accordance with the data control signals CONT2 from the signal control unit 600, and selects the gray voltages corresponding to the respective image data DAT from among the gray voltages from the gray voltage generation unit 800 to convert the image data DAT into the relevant data voltages, and transmits them to the relevant data lines D1-Dm.

The gate driving unit 400 applies the gate-on voltage Von to the gate lines G1-Gn in accordance with the gate control signal CONT1 from the signal control unit 600 to turn on the is main switching elements Q1 connected, e.g., coupled, with the gate lines G1-Gn. Thus, the data voltages applied to the data lines D1-Dm are applied to the relevant pixels via the turned-on main switching elements Q1.

The difference between the data voltage applied to the pixels and the common voltage Vcom is expressed by the charged voltage of the liquid crystal capacitor C_{LC}, e.g., by the pixel voltage. The arrangement of the liquid crystal molecules varies depending on a dimension of the pixel voltage, and accordingly, the polarization of the light passing through the liquid crystal layer 3 varies. The variation in the polarization is expressed by the variation in the light transmittance based on the polarizers (not shown) that are attached with the panels 100 and 200.

The operation described above with respect to the data driving unit 500 and the gate driving unit 400 is repeated for each horizontal cycle (one cycle of the horizontal synchronization signal Hsync, the data enable signal DE, and the gate clock CPV) or 1H, with respect to the pixels at the next pixel row. Accordingly, the gate-on voltages Von are sequentially applied to all the gate lines G1-Gn for one frame such that the data voltages are applied to all the pixels. When one frame is finished, another frame is initiated. The polarity of the reversal signals RVS applied to the data driving unit 500 is controlled such that the polarity of the data voltage applied to the respective pixels is opposite to the polarity thereof at the previous frame (frame inversion).

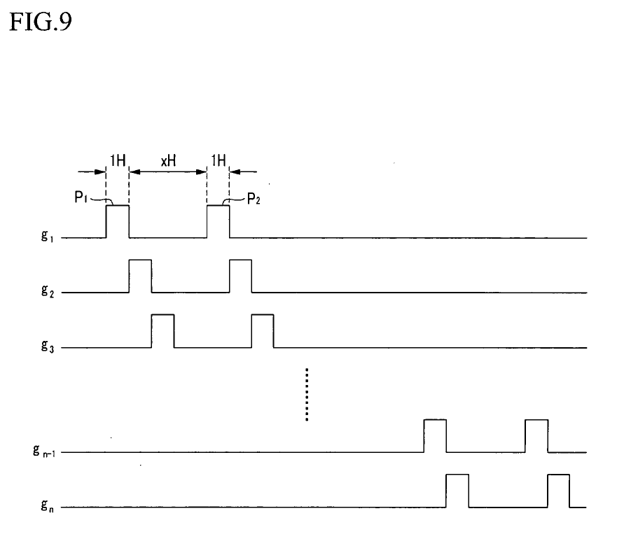

The preliminary charging operation of an LCD according to an embodiment of the present invention is described below with reference to FIG. 9.

FIG. 9 is a timing diagram showing the gate signals for the preliminary charging according to an embodiment of the invention.

As shown in FIG. 9, the gate-on voltages Von of the respective gate signals g₁-gₙ include a preliminary charge gate-on voltage P1 and a normal gate-on voltage P2, respectively. After outputting the preliminary charge gate-on voltage P1, the normal gate-on voltage P2 is output for a predetermined horizontal cycle xH, e.g., for 2H or a predetermined numbers of gate lines, by the difference of one gate line. As the data lines connected, e.g., coupled, with one pixel transmit the data voltages having the same polarity for one frame, the output gap between the preliminary charge gate-on voltage P1 and the normal charge gate-on voltage P2 may be arbitrarily established. It is understood that the preliminary charge gate-on voltage P1 and the normal charge gate-on voltage P2 may be continuously output without forming the output gap.

The preliminary charge gate-on voltages P1 are sequentially applied to the main switching elements Q1 at the relevant gate lines from the first gate line G1 to the last gate line Gn. The main switching elements Q1 are then turned on and the relevant pixels are preliminarily charged when receiving the data voltages opposite in polarity to those at the previous frame. Furthermore, after a predetermined horizontal cycle xH passes, the normal charge gate-on voltages P2 are sequentially applied to the main switching elements Q1 at the relevant gate lines. The main switching elements Q1 are then turned on and the relevant pixels receive their own data voltages through the turned-on main switching elements Q1.

As described above, with the frame inversion, the pixel is preliminarily charged by the data voltage having the same polarity as the polarity of the current frame before the polarity is charged by its own data voltage so that it may be sufficiently charged by its own data voltage for 1H. Accordingly, the driving capacity of the main switching elements Q1 may be enhanced through the preliminary charging.

Meanwhile, in addition to the frame inversion, the data driving unit 500 inverts the polarity of the data voltages flowing through the neighboring data lines D1-Dm within one frame, and accordingly, the polarity of the pixel voltages receiving the data voltages is also varied. However, as shown in FIGS. 6, 7, 8A, and 8B, the interconnection of the pixels and the data lines D1-Dm may be made in various manners so that the polarity inversion pattern at the data driving unit 500 and the polarity inversion pattern of the pixel voltages at the screen of the liquid crystal panel assembly 300 are not the same. The inversion made at the data driving unit 500 is referred to as the “driver inversion,” and the inversion made at the screen is referred to as the “apparent inversion.”

Inversion types according to embodiments of the invention are described with reference to FIGS. 6, 7, 8A, and 8B.

As shown in FIGS. 6, 7, 8A, and 8B, the driver inversion is the column inversion where the data voltages flowing through one data line have the same polarity, and the data voltages flowing through two neighboring data lines have opposite polarity.

According to the embodiment shown in FIG. 6, when the locations of the main switching elements are identical and the pixels arranged along one data line have the same polarity, the apparent inversion becomes the column inversion. According to the embodiment shown in FIG. 7, as the locations of the main switching elements Q1 are varied respectively per pixel rows, the apparent inversion becomes the 1×1 dot inversion. By contrast, according to the embodiments shown in FIG. 8A and FIG. 8B, as the locations of the main switching elements Q1 are varied per two pixel rows, the apparent inversion becomes the 2×1 dot inversion. Furthermore, when the locations of the main switching elements Q1 are varied per N numbers of pixel rows, the apparent inversion becomes the N×1 dot inversion.

When the above structure is applied to the LCD where the main switching element Q1 and the subsidiary switching element Q2 are arranged at one pixel such that they diagonally face each other, the vertical crosstalk is significantly reduced.

Vertical crosstalk is generated when the voltage of the pixel electrode is varied due to the parasitic capacitance between the pixel electrode and the neighboring data lines or the influence of the leakage current made after the pixel switching elements are turned off.

The voltage variation of the pixel electrode due to the parasitic capacitance between the pixel electrode and the data lines is described below with reference to FIG. 3.

As discussed, the pixel electrode 190 is connected, e.g., coupled, with the gate line Gi, the voltage line GL, and the data lines Dj-1 and Dj via the main switching elements Q1 and the subsidiary switching elements Q2. Parasitic capacitors C_{DP1} and C_{DP2} are formed between the pixel electrode 190 and the two neighboring data lines Dj-1 and Dj. The voltage variation ΔV due to the parasitic capacitors C_{DP1} and C_{DP2} between the pixel electrode 190 and the two neighboring data lines Dj-1 and Dj is determined by the following equation:
ΔV=(CDP1(V1−V1′)+CDP2(V2−V2′))/(CLC+CST+CGS+CDP1+CDP2) Equation 1

V1 is the data voltage applied to the data line Dj-1 when voltage is charged at the pixel electrode 190. V2 is the data voltage applied to the data line Dj when voltage is charged at the pixel electrode 190. V1′ is the data voltage flowing through the data line Dj-1 after voltage is charged at the pixel electrode 190. V2′ is the data voltage flowing through the data line Dj after voltage is charged at the pixel electrode 190. Furthermore, with Equation 1, C_{GS} is the gate-source parasitic capacitance of the main switching element Q1 and the subsidiary switching element Q2. C_{DP1} is the parasitic capacitance between the data line Dj-1 and the pixel electrode 190. C_{DP2} is the parasitic capacitance between the pixel electrode 190 and the next data line Dj. C_{LC} is the capacitance of the liquid crystal capacitor, and C_{ST} is the capacitance of the storage capacitor.

Considering the column inversion, and assuming that the data voltages flowing through the two neighboring data lines Dj-1 and Dj express the same gray, (V₂−C_{com})=−(V₁−V_{com}), and (V₂′−V_{com})=−(V₁′−V_{com}). Therefore, (V₂−V₂′)=−(V₁−V₁′). Accordingly, Equation 1 may be simplified into the following equation:

Equation 2
ΔV=(ΔCDP(V1−V1′))/(CLC+CST+CGS+CDP1+CDP2) (2)
ΔC_{DP}=C_{DP1}−C_{DP2}.

Meanwhile, the voltage variation ΔV of the pixel electrode 190 due to the leakage current is determined by the following equation:

Equation 3
ΔV=((Ioff1−Ioff2)×t)/(CLC+CST+CGS+CDP1+CDP2) (3)

t is the time when the data voltage different from the voltage charged at the pixel electrode 190 is applied to the data line Dj. I_{off1} is the leakage current between the pixel electrode 190 and the data line Dj-1 (the leakage current flowing through the subsidiary switching element). I_{off2} is the leakage current between the pixel electrode 190 and the data line Dj (the leakage current flowing through the main switching element). The leakage current has a positive value or a negative value depending on the polarity of the difference between the voltage of the pixel electrode 190 and the voltage of the data lines Dj-1 and Dj.

As shown in FIG. 3, the main switching element Q1 and the subsidiary switching element Q2 have the same-structured and diagonally face each other at one pixel, and hence, the geometrical structures of the pixel electrode 190 from the viewpoints of the two neighboring data lines Dj-1 and Dj are substantially identical with each other. Consequently, the parasitic capacitances C_{DP1} and C_{DP2} are substantially identical with each other, and hence, the voltage variation due to the difference between the two parasitic capacitances C_{DP1} and C_{DP2} is minimal.

As the main switching element Q1 and the subsidiary switching element Q2 are connected, e.g., coupled, with the data lines receiving the data voltages having opposite polarity, the leakage current I_{off1} flowing in through the subsidiary switching element Q2 flows out through the main switching element Q1, while the leakage current I_{off2} flowing in through the main switching element Q1 flows out through the subsidiary switching element Q2. As the main switching elements Q1 and the subsidiary switching elements Q2 have the same structure, the dimensions of the two leakage currents I_{off1} and I_{off2} are nearly identical to each other so that I_{off1}−I_{off2}≈0. Consequently, the voltage variation ΔV of the pixel electrode 190 is reduced, and the influence of the vertical crosstalk is decreased.

Furthermore, as shown in FIGS. 7, 8A, and 8B, when the apparent inversion becomes a dot inversion, a main switching element Q1 and a subsidiary switching element Q2 are arranged at one pixel to decrease the vertical crosstalk influence and the luminance difference caused by the kickback voltage is reduced when the pixel voltage is in a positive polarity state and in a negative polarity state so that defects at the vertical pixel rows are decreased. Furthermore, as the locations of the main switching elements Q1 are varied per pixel row group, it is more probable than not that the data voltages having opposite polarity to each other but nearly the same value will be applied to the neighboring data lines during the ½ frame except at a borderline area of the image. Consequently, the voltage variation of the pixel electrode 190 is significantly reduced so that the influence of the vertical crosstalk decreases.

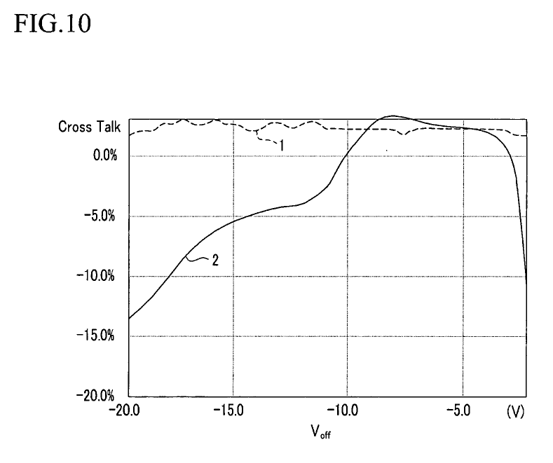

Experimental results relating to the vertical crosstalk generated from the gate-off voltage of an LCD are described below with reference to FIG. 10.

The curve 1 shown in FIG. 10 refers to the vertical crosstalk of the LCD according to an embodiment of the invention, and the curve 2 thereof indicates the vertical crosstalk of a conventional LCD having one switching element.

A substantially rectangular black pattern was displayed at the center of the screen of the respective LCDs, and a gray scale was displayed on the remaining screen area. Luminance was measured at the locations influenced by the vertical crosstalk. The ratio of the luminance at the center of the screen to the luminance at the gray scale area was measured and represented by the vertical crosstalk.

The experiments were conducted while varying the gate-off voltage in the range of about −20V to about ˜−2V and applying the gate-off voltage to the switching elements.

Referring to the LCD indicated by the curve 1 of FIG. 10, the crosstalk was constantly kept in the level of about 2% even though the gate-off voltage was varied. However, referring to the conventional LCD indicated by the curve 2 of FIG. 10, the crosstalk was significantly increased when the gate-off voltage was varied. The luminance significantly varies due to the influence, e.g., increase, of the crosstalk.

The leakage current of the switching elements was varied depending upon the gate-off voltage, and the lowest value thereof was generated at −7V. With the conventional LCD, the larger the leakage current, the more the vertical crosstalk increased, and radically so. By contrast, with the LCD of the invention, the vertical crosstalk was not nearly as influenced by the leakage current as the conventional LCD was.

As described above, when the main and the subsidiary switching elements at the respective pixels are connected, e.g., coupled, with data lines that are different from each other, and column inversion driving is performed, the crosstalk generation is significantly reduced and the image quality of the LCD improves. Further, when the locations of the data lines connected, e.g., coupled, with the main switching elements and the subsidiary switching elements at the neighboring pixel row groups are varied, the apparent inversion may be the N×1 dot inversion even though the driver inversion is the column inversion. As the polarity of the data voltage is determined at the data driving unit in the column inversion type and applied, a variety of materials for the data lines may be used. Consequently, the relevant processing steps are simplified, and because the apparent inversion is the dot inversion, the crosstalk is reduced, which improves the image quality.

Moreover, the voltage line for transmitting the gate-off voltage is connected, e.g., coupled, with the control terminal of the subsidiary switching element so that with the frame inversion, the relevant pixel may be preliminarily charged by the data voltage with the same data voltage as that at the current frame before being charged by its own data voltage. Accordingly, the pixel is sufficiently charged by its own data voltage for 1H, and as a result, the driving capacity of the main switching element can be enhanced.

Furthermore, the voltage line is commonly used as the storage electrode line for a storage capacitor so that the aperture ratio of the pixel can be prevented from being deteriorated.

It will be apparent to those skilled in the art that various modifications and variation can be made in the present invention without departing from the spirit or scope of the invention. Thus, it is intended that the present invention cover the modifications and variations is of this invention provided they come within the scope of the appended claims and their equivalents.

What is claimed is:

1. A liquid crystal display (LCD), comprising:
a plurality of pixel rows including a plurality of pixels in a matrix-like arrangement, each pixel row having a first switching element, a second switching element, and a pixel electrode coupled with the first switching element and the second switching element;
a gate line coupled with the first switching element to transmit a gate-on voltage thereto; and
a data line coupled with the first switching element and the second switching element to transmit a data voltage thereto,
wherein the first switching element and the second switching element at each of the respective pixels are coupled with different data lines, and the second switching element is in a turned-off state.

2. The LCD of claim 1, wherein the first switching element and the second switching element are arranged such that a leakage current flowing through the first switching element is substantially the same as a leakage current flowing through the second switching element.

3. The LCD of claim 1, wherein a first parasitic capacitor and a second parasitic capacitor having substantially the same capacitance as the first parasitic capacitor are provided between the pixel electrode and the two adjacent data lines, respectively.

4. The LCD of claim 1, further comprising:
a voltage line coupled with the second switching element to transmit a gate-off voltage thereto.

5. The LCD of claim 4, further comprising:
a first storage capacitor provided between the voltage line and the pixel electrode.

6. The LCD of claim 5, further comprising:
a storage electrode line to transmit a predetermined voltage; and
a second storage capacitor provided between the storage electrode line and the pixel electrode.

7. The LCD of claim 6, wherein the predetermined voltage is a common voltage.

8. The LCD of claim 1, wherein the data voltages flowing along adjacent data lines have opposite polarities to each other.

9. The LCD of claim 8, wherein the data voltages flowing along the respective data lines have the same polarity.

10. The LCD of claim 8, wherein the data voltages flowing along the respective data lines have the same polarity for at least one frame.

11. The LCD of claim 10, wherein the polarity of the data voltages applied to the pixels is varied for respective frames, and the gate-on voltages comprise a preliminary charge gate-on voltage and a normal charge gate-on voltage that is output after the preliminary charge gate-on voltage is output.

12. The LCD of claim 1, wherein each of the first switching elements are coupled with a same-side of the data lines, and each of the second switching elements are coupled with a same-side of the data lines.

13. The LCD of claim 1, wherein each of the first switching elements is alternately coupled with a same-side of the data lines for N number of pixel rows where N is a natural number, and each of the second switching elements is alternately coupled with a same-side of the data lines for the N numbers of pixel rows.
